(19) United States
(12) Patent Application Publication
(10) Pub. No.: US 2025/0384280 A1
(43) Pub. Date: Dec. 18, 2025

(54) TRAINING DATA GENERATION FOR LARGE LANGUAGE MODEL FINE-TUNING AND/OR BENCHMARKING

(71) Applicant: Intuit Inc., Mountain View, CA (US)

(72) Inventors: Nitzan GADO, Ness Zionna (IL); Linoy COHEN, Ramat Gan (IL); Lior VASSERTAIL AZROEL, Rosh Ha’ayin (IL); Kfir AHARON, Ness Zionna (IL); Osnat HAJ YAHIA, Tayibe (IL); Oren DAR, Ness Zionna (IL); Matan VETZLER, Ramat Gan (IL); Shai ARDAZI, Petah Tikva (IL); Guy LEV, Givatayim (IL); Raphael VANNEROM, Tel Aviv (IL)

(21) Appl. No.: 18/744,366

(22) Filed: Jun. 14, 2024

(51) Int. Cl. G06N 3/0895

(52) U.S. Cl. CPC G06N 3/0895

(57) ABSTRACT

Certain aspects of the disclosure provide techniques for training data generation for large language model (LLM) training and/or benchmarking. A method generally includes obtaining domain data associated with a domain; generating a prompt based on configuration parameter(s) included in a configuration file, the prompt comprising: a request to generate training data for the domain based on the domain data, wherein the training data comprises: a first plurality of question and answer pairs; a conversation comprising a first plurality of questions and a first plurality of answers corresponding to the first plurality of questions; a second plurality of questions; or a question and a second plurality of answers corresponding to the question; guideline(s) for generating the training data; example training data for the domain; and the domain data; prompting an LLM with the prompt to generate the training data; and receiving, from the LLM, the training data based on the prompt.

### BACKGROUND

### Field

Aspects of the present disclosure relate to generating training data for fine-tuning and/or benchmarking large language model (LLM) training.

### Description of Related Art

A key long-term goal of artificial intelligence (AI) is to create machines capable of understanding and engaging in conversation with humans using natural language. Dialogue systems, which can communicate with users in natural language, may carry out unstructured conversations, with users, on any topic (e.g., open-domain systems). Performant dialogue systems exhibit competence in understanding natural language, making informed decisions, and generating fluent, engaging, contextually appropriate, and accurate responses.

An example dialogue system may leverage large language model(s) (LLM(s)) to perform natural language processing (NLP) tasks. An LLM is a type of machine learning (ML) model that supports NLP tasks, such as generating text, analyzing sentiments, answering prompts (e.g., specific instructions and/or requests posed in natural language) in a conversational manner, translating text from one language to another, and/or the like. LLMs makes it possible for software to “understand” typical human speech or written content and respond to it by, in some cases, generating human-understandable responses through natural language generation (NLG).

A popular LLM, which has gained much recent attention, is “ChatGPT,” produced by OpenAIR. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible responses based on their understanding of the language.

While LLMs, such as ChatGPT, represent a transformative force in many industries by enabling developers to build conversation-driven applications, these models are not without limitation. For example, while a powerful tool, an LLM is only as good as the underlying training data used to train the model.

Pre-training is the initial phase of training for LLMs. Pre-training starts with an untrained model (e.g., a model that has randomly initialized weights), and trains it to predict a next token given a sequence of previous tokens. In the context of LLMs, tokens may be units of text that the models process and generate. Tokens can represent individual characters, words, subwords, or even larger linguistic units, depending on the specific tokenization (e.g., segmentation of text into meaningful units to capture its semantic and syntactic structure) approach used. Tokens act as a bridge between the raw text data and the numerical representations that LLMs are able to work with. Training data used to pre-train an LLM generally includes publicly available “raw text,” for example, from books, articles, websites, and/or the like. To be highly capable (e.g., have linguistic and world knowledge), this text may span a broad range of domains, genres, languages, etc. Eventually, training on large amounts of text, the model learns to encode the structure of language in general (e.g., it learns, that “I like,” for example may be followed by a noun or a participle) as well as the knowledge included in the raw texts that the model was exposed to during training. For example, an LLM may learn, that the sentence “George Washington was . . . ” is often followed by “the first president of the United States,” and hence has a representation of that piece of knowledge.

Although a pre-trained LLM is, due to the knowledge it encodes, able to perform a variety of tasks, the model may lack specific domain knowledge that is not encoded in the training data. This presents a technical problem in cases where the knowledge artifacts necessary for accurately responding to a prompt are partly, or completely, private, internal to an organization, etc. For example, a general-purpose LLM (e.g., off-the-shelf LLM) pre-trained on publicly-available data may not be able to respond, or may respond incorrectly, to a domain-specific prompt, such as a prompt requesting information about employee retention at a particular company for a previous year, a prompt requesting customer help with an application and/or system internal to a company, and/or the like. The pre-trained LLM may not be able to respond or may respond incorrectly given the information that is requested is not part of the publicly available training data used to pre-train the LLM.

### SUMMARY

Certain aspects provide a method comprising: obtaining domain data associated with a first domain; generating a first prompt based on one or more configuration parameters included in a configuration file, the first prompt comprising: a request to generate first training data for the first domain based on the domain data, wherein the first training data comprises: a first plurality of question and answer pairs; a conversation comprising a first plurality of questions and a first plurality of answers corresponding to the first plurality of questions; a second plurality of questions; or a question and a second plurality of answers corresponding to the question; one or more first guidelines for generating the first training data; example first training data for the first domain; and the domain data; prompting a first large language model (LLM) with the first prompt to generate the first training data; and receiving, from the LLM, the first training data based on the first prompt.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example workflow for generating training data used to fine-tune and/or benchmark a large language model for a particular domain.

FIG. 2 depicts an example configuration file used for generating training data.

FIG. 3 depicts an example prompt template for generating a prompt.

FIG. 4 depicts the example generation of domain-specific training data, including question and answer pairs.

FIGS. 5A-5C depict the example generation of domain-specific training data including question and answer pairs, where the questions and answers are generated separately.

FIG. 6 depicts the example generation of domain-specific training data, including textual conversation(s).

FIG. 7 depicts the example generation of domain-specific training data, including multiple choice question and their corresponding answer(s).

FIG. 8 depicts an example method for generating domain-specific training data for large language model fine-tuning and/or benchmarking.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

To address the shortcomings of general-purpose LLMs, some conventional approaches seek to combine and orchestrate LLM functionality with other sources of knowledge. For example, some conventional approaches use techniques to “fine-tune” LLMs for specific domains. Fine-tuning LLMs for specific domains involves adapting a pre-trained language model to generate domain-specific text and/or initiate or perform domain-specific tasks. This process allows the model to better understand and generate content that aligns with the particular domain and/or topic/area of interest. In certain embodiments, after fine-tuning the LLM for the specific domain, “benchmarking” may be performed to evaluate the ability of the LLM to generate logical responses to a variety of domain-specific prompts. For example, benchmarking may involve testing and measuring the performance of a fine-tuned LLM for a specific domain.

It has been recognized, however, that an obstacle to effectively fine-tuning and/or benchmarking an LLM for a particular domain is related to the insufficient amount of domain-specific training data available for training the LLM. For example, LLM fine-tuning and/or benchmarking may be dependent on the availability of large, high-quality, domain-specific datasets. In general, the more facets the data covers, the faster the LLM can learn and fine-tune its output (e.g., generate content and/or human-understandable responses through NLG that align with a particular domain). In some cases, if the data used for training an LLM is not sufficiently diverse and/or unbiased, problems such as “AI bias” may arise. AI bias is an anomaly in which the inherent bias of training data causes an LLM, trained based on that data, to inherent the same bias. Four example types of data bias that are relevant to LLMs include (1) selection bias, (2) temporal bias, (3) implicit bias, and (4) social bias. As such, the lack of available and high-quality domain-specific training data hinders the ability of LLMs to understand and generate accurate response(s) and/or content for the domain. Further, the lack of such data may also delay benchmarking and/or produce inaccurate benchmarking results for the LLM when evaluated. As used herein, high-quality training data may refer to training data that is (1) comprehensive, (2) diverse, (3) accurate, (4) relevant, and (4) not biased.

Some existing methods for generating training data are used to build a comprehensive data corpus that may be useful for training, or fine-tuning, and/or benchmarking LLMs for a particular domain. For example, these methods may be used to manually (1) gather and integrate domain-specific data from various sources to generate a domain-specific dataset, (2) clean and filter the dataset to identify and rectify inconsistencies, errors, and/or irrelevant information within the dataset, (3) add metadata, tags, and/or annotations to the dataset to provide context and meaning to the raw data, (4) partition the dataset into training, validation, and testing datasets, and (5) ensuring that the datasets are compatible with an LLM that is to be fine-tuned. While such methods for training data generation allow for creating training data that can then be used to train and/or benchmark an LLM to generate contextually appropriate responses to a variety of domain-specific prompts, manually generating training data using such existing methods may be cumbersome and time-consuming. Thus, it may take a very long time or even be impractical to develop LLMs that understand and generate domain-specific data.

Further, managing this pipeline for generating training data and ensuring that the training data is always fresh, relevant, and includes high-quality (e.g., comprehensive, diverse, accurate, relevant, and unbiased) data is a technical challenge, especially as the amount and/or types of training data needed increases. In some cases, these data generation and management challenges may be significant, for most of the effort involved in fine-tuning and/or benchmarking an LLM for a specific domain may be tied up in generating and ensuring the quantity and quality of training data for the LLM. In some cases, fine-tuning and/or benchmarking an LLM for a specific domain may not occur at least due to the inherent difficulty in obtaining and managing domain-specific training data for training and/or benchmarking the LLM. Thus, the benefits of using LLMs in one or more domain-specific contexts may not be realized.

Accordingly, improved techniques for domain-specific training data generation, which may be used to fine-tune an LLM to understand and generate content specific to that domain, are desired. Domain-specific training data, which may be used to benchmark the LLM, may also be desired.

Embodiments described herein overcome the aforementioned technical problems and improve upon the state of the art by providing techniques for automatically (e.g., with little or no direct human control) generating domain-specific training data for LLM training (also referred to herein as “LLM fine-tuning”) and/or benchmarking. For example, in certain embodiments, a data builder system is employed to execute one or more training data generation tasks (also referred to herein as “generation tasks”) for the generation of synthetic training data (simply referred to herein as “training data”). During generation task execution, the data builder system may (1) obtain domain data (e.g., articles data, glossary data, conversational data, etc. associated with a specific domain), (2) generate a prompt, and (3) provide the prompt to one or more LLMs to generate training data from the domain data. As used herein, a prompt is a specific instruction and/or request, usually posed in natural language, to perform a useful function, such as training data generation. Different generation tasks of different types may be executed by the data builder system to generate different prompts. The different prompts may be used to instruct and/or request the generation of training data for the domain having various formats, such as question and answer pairs, textual conversations, and/or multiple choice questions and answers, to name a few. Accordingly, a comprehensive and diverse set of training data for the specific domain may be generated when multiple generation tasks, of different types, are executed by the data builder system. In certain embodiments, the data builder system is designed to execute multiple generation tasks in parallel to generate the training data for the specific domain. In some cases, the training data generated by the data builder system may be used to train another LLM to generate domain-specific text and/or initiate or perform domain-specific tasks. In some cases, the training data generated by the data builder system may be used for LLM benchmarking.

In certain embodiments, the data builder system performs a generation task based on configuration parameter(s) (simply referred to herein as “parameter(s)”) included in a configuration file associated with the generation task. For example, parameter(s) for a generation task may be outlined in a configuration file provided to the data builder system. The parameter(s) may govern various aspects of the generation task. The parameter(s) may indicate the generation task's type and instructions for carrying out the generation task. For example, one configuration file may indicate that the generation task comprises a “conversation” generation task type and instruct that a real chat, between a customer and an expert, is to be generated based on rephrasing an article (e.g., example domain data). Further, the parameter(s) may indicate the domain data and/or a specific LLM to use for generating the domain-specific training data, among others.

The data builder system may generate a prompt based on parameter(s) included in a configuration file provided to the data builder system to carry out a generation task. In certain embodiments, the prompt is generated to include a specific instruction and/or request to generate the training data. In certain embodiments, the prompt is further generated to include (1) guideline(s), (2) formatting instructions, and/or (3) example training data to help improve the accuracy of the training data generated by an LLM provided the prompt.

The data builder system described herein provides significant technical advantages over conventional methods for generating domain-specific training data, such as an ability to generate high-quality, domain-specific training data in an efficient manner and at scale.

For example, including additional prompt information (e.g., beyond just a request and/or instruction(s) to be carried out) in a prompt provided to an LLM of the data builder system improves the accuracy of training data generated by the LLM. In particular, the LLM may produce training data that meets particular criteria (e.g., is high-quality) for effective use in fine-tuning another LLM. Further, the use of multiple generation tasks to create various types of training data beneficially improves the diversity of the training data used to fine-tune and/or benchmark the other LLM to avoid the presence of any AI bias in the language model.

As another example, the execution of generation tasks based on configuration files created for the generation tasks helps to simplify the process of generating domain-specific training data. Specifically, the configuration files include parameters that may be universally applied to different domains for the generation of domain-specific training data from different formats of raw domain data. Additionally, the ability of the data builder system to operate tasks in parallel beneficially reduces latency in generating training data used to train an LLM for a particular domain.

Furthermore, the configuration files used by the data builder system described herein make it easier to scale training data generation tasks to other domains and/or for the generation of other training data formats (e.g., question and answer pairs, textual conversations, multiple choice questions and answers, etc.). For instance, by simply changing the type of domain data specified in the configuration file, a generation task associated with the configuration file may be performed for different domain data to generate training data for an additional domain. Further, by simply changing the instructions included in the configuration file, a generation task associated with the configuration file may be performed to generate training data having a new format.

Example Workflow for Generating Domain-Specific Training Data for LLM Fine-Tuning and/or Benchmarking

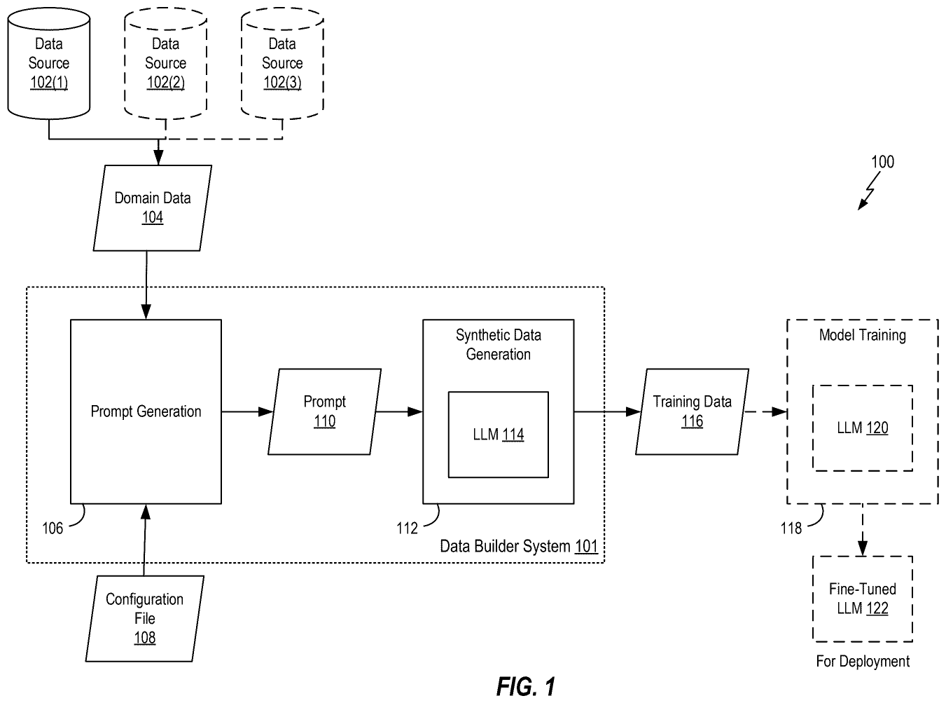

FIG. 1 depicts an example workflow 100 for generating training data, which may be used for fine-tuning and/or benchmarking an LLM for a particular domain (e.g., create and/or evaluate a “domain-specific LLM”). The training data generated according to workflow 100 may include text data that is specific to a particular domain (e.g., finance, law, healthcare, real estate, an organization, etc.), such that when this training data is used to fine-tune the LLM, the LLM is able to obtain a deep understanding of the linguistic nuances within the particular domain. As such, the LLM may be able to communicate effectively with specialized vocabulary and provide high-quality responses associated with the domain.

As shown in FIG. 1, workflow 100 includes prompt generation 106, synthetic data generation 112, and model training 118. Prompt generation 106 and synthetic data generation 112 may be performed by a data builder system 101. As described above, the data builder system 101 may be designed to execute one or more generation tasks for the generation of synthetic training data (e.g., training data 116 in FIG. 1).

Workflow 100 begins with prompt generation 106. Prompt generation includes generating a prompt 110 based on parameter(s) included in a configuration file 108 and domain data 104. For example, prompt generation 106 may include data builder system 101 reading and parsing a configuration file 108. In certain aspects, configuration file 108 is stored in a datastore accessible by data builder system 101. In certain aspects, configuration file 108 is provided to data builder system 101.

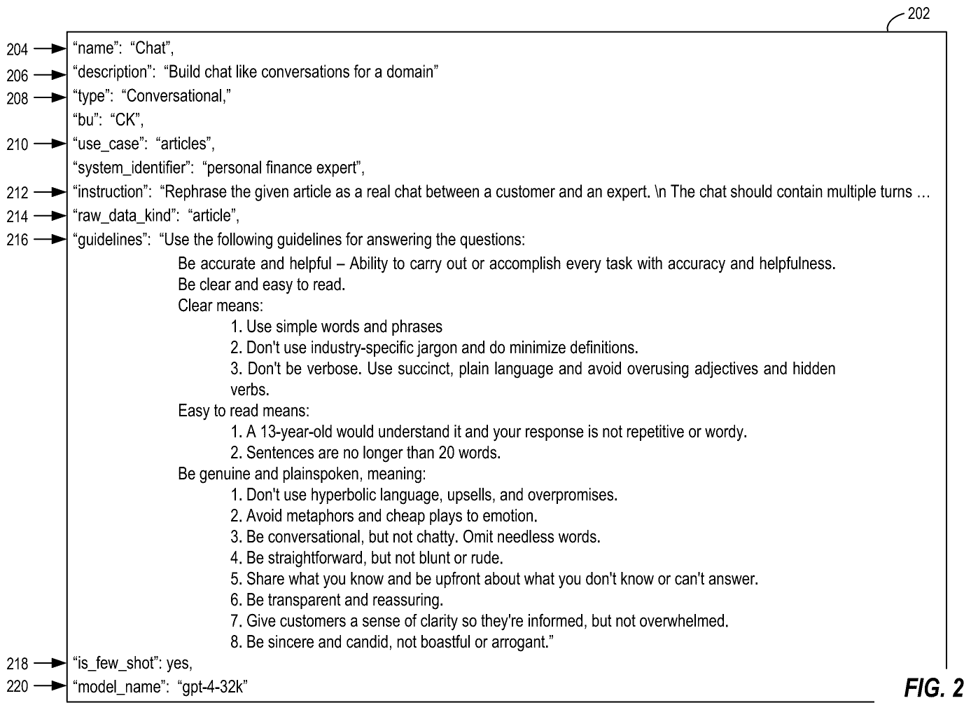

Configuration file 108 may include one or more parameters for carrying out a generation task. The generation task may comprise generating training data, such as question and answer pairs using a single prompt (e.g., a first task type, referred to herein as a “single stage Q&A task”). In certain aspects, the generation task is generating training data as question and answer pairs using one prompt to generate the questions and multiple prompts to generate the answers (e.g., a second task type, referred to herein as a “two stage Q&A task”). In certain aspects, the generation task is generating training data as a single chat, which may include question(s) and/or answer(s) (e.g., a third task type, referred to herein as a “conversational task”). In certain aspects, the generation task is generating training data as a multiple choice question, with one right answer (e.g., a fourth task type, referred to herein as a “multiple choice task”). It is noted that the above-described task types are not an exhaustive list, and a configuration file 108 may include parameter(s) for carrying out various other generation task types. An example configuration file 108, including multiple parameters, is depicted and described with respect to FIG. 2.

The parameters of configuration file 108 may indicate at least the type of generation task to perform, instructions for how to perform the generation task to generate training data 116, and domain data 104 from which training data 116 is to be generated (e.g., provided as an identifier of domain data 104, a location of domain data 104, a pointer to the location of domain data 104, etc.). However, other parameter(s) may be included in configuration file 108, as depicted and described with respect to FIG. 2. In certain embodiments, domain data 104 includes data from one or more data sources 102 (e.g., shown as data sources 102(1)-(3)), such as conversational data, articles data, glossary data, book data, etc. associated with a particular domain. At prompt generation 106, a prompt 110 may be automatically generated using these parameters.

Prompt 110 may be generated as input (e.g., a question, a query, a command, etc.) for an LLM 114 to perform a specific generation task (e.g., at synthetic data generation 112). Put differently, prompt 110 may be a specific instruction and/or request, posed in natural language, that may be given to LLM 114 to generate training data 116 of a specific type. Prompt 110 may include terms and/or phrases spoken normally and/or entered as they might be spoken, without any special format and/or alteration of syntax.

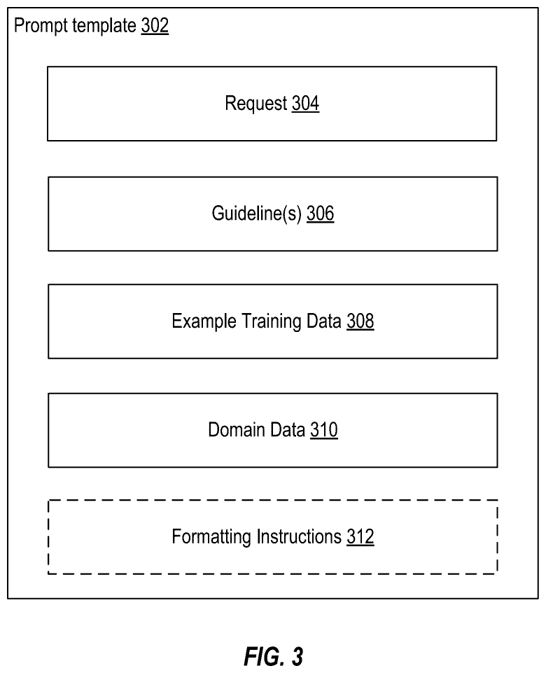

Prompt 110 may include (1) a request to generate training data 116 based on domain data 104, (2) guideline(s) for generating training data 116, (3) one or more examples of training data 116 that LLM 114 is requested to generate, (4) the domain data 104, an indication of a location where domain data 104 is stored, and/or a pointer to the location of domain data 104, and/or (5) formatting instruction(s) for formatting training data 116. An example prompt including this information is depicted and described with respect to FIG. 3.

The request to generate training data 116, included in prompt 110, may be a request to create a specific type of training data 116 indicated in configuration file 108. Further, the domain data 104, included in prompt 110 (or included as its location or pointer to its location), may comprise the domain data indicated in configuration file 108.

After generation of prompt 110, workflow 100 proceeds to synthetic data generation 112. Synthetic data generation 112 may also be performed by data builder system 101. Synthetic data generation 112 may use LLM 114 to generate training data 116. For example, synthetic data generation 112 may include prompting LLM 114 with prompt 110 to generate training data 116. Training data 116 generated based on prompt 110 may be generated with a specific format (e.g., question and answer pairs, a chat, etc.) based on the request included in prompt 110. In certain embodiments, LLM 114 is a GPT-4 model.

In certain embodiments, training data 116 is used to train another LLM 120. For example, workflow 100 may proceed with model training 118. In some cases, model training 118 includes fine-tuning LLM 120 for a domain (e.g., the domain associated with training data 116) using training data 116. In some cases, model training 118 includes benchmarking LLM 120 to evaluate the performance of LLM 120 in generating responses for a domain. After model training 118, a fine-tuned LLM 122 may be deployed to generate domain-specific text and/or initiate or perform domain-specific tasks.

Although FIG. 1 depicts the generation of training data 116 of a single type from domain data 104 based on a single configuration file 108, in certain other embodiments, training data 116 of multiple types (e.g., having different formats) may be generated from domain data 104 based on multiple configuration files 108. For example, a first configuration file 108 may prompt a first generation task (e.g., a single stage Q&A task) to generate training data 116 of a first type, a second configuration file 108 may prompt a second generation task (e.g., a two stage Q&A task) to generate training data 116 of a second type, and so-on. Thus, in such cases, multiple prompts 110 may be generated at prompt generation 106 and provided to LLM 114 for synthetic data generation 112. Further, in certain embodiments, generation of each of the different types of training data 116 based on multiple configuration files 108 may be performed in parallel (e.g., multiple generation tasks may be carried out simultaneously).

Additionally, although FIG. 1 depicts the generation of training data 116 from domain data 104 associated with a single domain, in certain other embodiments, workflow 100 may be used to generate training data 116 from domain data associated with multiple domains. Accordingly, a first set of training data associated with a first domain may be generated (e.g., based on at least one configuration file 108), a second set of training data associated with a second domain may be generated (e.g., based on at least another configuration file (not shown)), and/or etc.

FIG. 2 depicts an example configuration file 202. Configuration file 202 may be an example of configuration file 108 depicted and described with respect to FIG. 1. As described herein, configuration file 202 may be accessible by and/or provided to a data builder system (e.g., such as data builder system 101 in FIG. 1) for generating training data (e.g., such as training data 116 in FIG. 1).

In certain embodiments, configuration file 202 includes (1) information about a generation task that is to be carried out by a data builder system and (2) configuration parameter(s) that govern various aspects of and/or are associated with the generation task. The configuration parameter(s) may include a configuration file name, a configuration file description, a generation task type associated with the configuration file 202 (e.g., a generation task type to be executed by the data builder system), a type of domain data used for the generation task associated with configuration file 202, which domain data to use for carrying out the generation task, one or more instructions for carrying out the generation task associated with configuration file 202, one or more guidelines for carrying out the generation task associated with configuration file 202, an indication of a model (e.g., an identifier of an LLM) to use for carrying out the generation task associated with configuration file 202, and/or an indication as to whether or not example training data (referred to as “shots” in one-shot and/or few-shot prompting) is available for prompting, and/or. As used herein, one-shot prompting and few-shot prompting are prompting techniques that offer example demonstration(s) (e.g., example training data that may be generated by the LLM) within a prompt for in-context learning to guide the LLM towards better performance (e.g., better training data generation). One-shot prompting may involve including a single demonstration example in a prompt. Few-shot prompting may involve include two or more demonstration examples in a prompt.

For example, as shown in FIG. 2, example configuration file 202 includes information about a “conversational task” (e.g., an example generation task type) for generating training data as a single chat, which may include one or more questions and/or one or more answers. Example configuration file 202 includes a “name” parameter 204 specifying the name of the configuration file 202 as “Chat” and a “description” parameter 206 specifying that the “Chat” configuration file 202 is used to “Build chat like conversations for a domain.” Example configuration file 202 further includes a “type” parameter 208 indicating a generation task type as “Conversational” and an “instruction” parameter 212 indicating that executing (e.g., carrying out) the conversational task type includes “Rephras[ing] the given article as a real chat between a customer and an expert. . . . The chat should contain multiple turns . . . ” In other words, example configuration file 202 is associated with a conversational task type for generating training data as a single chat from an article specified in example configuration file 202.

Configuration file 202 further includes a “use_case” parameter 210 specifying the intended use case as “articles,” and a “raw_data_kind” parameter 214 indicating “article,” which specifies the domain data that is to be used to generate the training conversational training data.

Additionally, example configuration file 202 includes a “guidelines” parameter 216 indicating guidelines for generating the conversational training data specifying to:
“Use the following guidelines for answering the questions:
Be accurate and helpful—Ability to carry out or accomplish every task with accuracy and helpfulness. Be clear and easy to read.
Clear means:
   1. Use simple words and phrases
   2. Don't use industry-specific jargon and do minimize definitions.
   3. Don't be verbose. Use succinct, plain language and avoid overusing adjectives and hidden verbs.
Easy to read means:
   1. A 13-year-old would understand it and your response is not repetitive or wordy.
   2. Sentences are no longer than 20 words.
Be genuine and plainspoken, meaning:
   1. Don't use hyperbolic language, upsells, and overpromises.
   2. Avoid metaphors and cheap plays to emotion.
   3. Be conversational, but not chatty. Omit needless words.
   4. Be straightforward, but not blunt or rude.
   5. Share what you know and be upfront about what you don't know or can't answer.
   6. Be transparent and reassuring.
   7. Give customers a sense of clarity so they're informed, but not overwhelmed.
   8. Be sincere and candid, not boastful or arrogant.”

Example configuration file 202 also includes an “is_few_shot” parameter 218 indicating that example training data is available to learn from when carrying out the conversational task. Further, example configuration file includes a “model_name” parameter 220 specifying that a ChatGPT model named “gpt-4-23k” is to be used for the generation of the conversation training data. It is noted that the above-described parameters included in example configuration file 202 are an example of one set of parameters that may be included in a configuration file. Other examples may have additional, fewer, and/or different parameters.

As described herein, a prompt may be automatically generated from the parameter(s) included in a configuration file. FIG. 3 depicts a prompt template 302 for an example prompt generated based on parameter(s) included in a configuration file. Prompt template 302 provides an outline of the information that may be included in a prompt generated by a data builder system (e.g., such as data builder system 101 in FIG. 1).

As shown in FIG. 3, a prompt may include a request 304, guideline(s) 306, example training data 308, domain data 310, and optionally, formatting instructions 312.

Request 304 may include a specific instruction to generate training data. For example, request 304 may include instructions that invite a response and/or action, such as the generation of training data, by an LLM receiving a prompt based on prompt template 302. In certain embodiments, request 304 indicates the type of training data that is to be generated by the LLM. In certain embodiments, request 304 is based on a generation task type included within a configuration file used to create the prompt, such as information included for “type” parameter 208 in FIG. 2. For example, if a configuration file indicates that the generation task type is a conversational task type, then request 304 may include instructions such as “Rephrase the given article as a real chat between a customer and an expert.” In certain embodiments, request 304 is based on one or more instructions for carrying out a generation task included within a configuration file used to create the prompt, such as information included for “instruction” parameter 212 in FIG. 2. For example, if a configuration file includes instructions to “Rephrase the given article as a real chat between a customer and an expert” (e.g., as shown in FIG. 2), then request 304 may include instructions such as “Rephrase the given article as a real chat between a customer and an expert” (however, the request 304 may not always mimic exactly the instructions included in the configuration file).

Guideline(s) 306 may be included in a prompt to guide an LLM, receiving the prompt, to focus on providing a more in-depth, thoughtful, and/or accurate responses to a request 304. For example, guideline(s) 306 may encourage the LLM to consider some information more carefully before producing a response, such that the produced response meets some criteria (e.g., is well-considered, accurate, comprehensive, etc.). In certain embodiments, the guideline(s) 306 may provide information about how to generate a “good” response (e.g., a response that satisfies some criteria) to request 304, and more specifically how to generate “good” training data for a specific generation task and/or a specific domain. For example, a request 304, included in a prompt, may include instructions to create question and answer pairs for the real estate domain (e.g., the generation task type is a single stage Q&A task). Thus, guideline(s) 306, included in the prompt, may include a first suggestion to consider different granularities associated with the real estate domain, such as locations, developing areas, etc., when generating the training data. Further, guideline(s) 306, included in the prompt, may include a second suggestion to consider different nuances associated with the real estate domain when generating the training data. Other guideline(s) 306 included in a prompt may include suggestion(s) to “be accurate,” “be helpful,” “use simple, unambiguous language that avoids jargon and overly complex vocabulary,” and/or “produce only English responses,” to name a few.

In certain embodiments, guideline(s) 306 are based on one or more guidelines for carrying out a generation task included within a configuration file used to create the prompt, such as information included for “guidelines” parameter 216 in FIG. 2. For example, if a configuration file includes guidelines to “Be accurate and helpful” (e.g., as shown in FIG. 2), then guideline(s) 306 may include a suggestion to “Please make sure each answer generated for a question is accurate and helpful to answer the specific question.”

Example training data 308 may include one or more demonstration examples (e.g., one or more “shots” in one-shot and/or few-shot prompting) that an LLM may learn from when prompted to generate training data. Example training data 308 may be provided in a prompt to guide the LLM to respond in a specific way. For example, example training data 308 including in a prompt may be used to regulate the formatting, phrasing, scoping, and/or general patterning of LLM responses based on the prompt. Providing specific and varied example training data 308 in a prompt may help the LLM narrow its focus and generate more accurate response (e.g., generate more accurate training data). As an illustrative example, in the real estate domain, example training data 308 included in a prompt may include a few dozen questions related to the real estate domain (e.g., “What is a seller's market?,” “What is a buyer's market?,” “What kind of credit score do I need to buy a home?” “How much money do I need for a down payment?,” etc.). In some cases, the questions may be in various different formats and/or be related to various different topics and/or problems related to real estate.

In certain embodiments, example training data 308 is based on an indication included in a configuration file indicating whether or not example training data is available for prompting, such as shown via “is_few_shot” parameter 218 in FIG. 2. For example, if “is_few_shot” parameter 218 says “yes,” as shown in FIG. 2, then example training data 308 may be available. This example training data 308 may include pre-defined demonstration examples previously provided to the data builder system (e.g., such as data builder system 101 in FIG. 1). The pre-defined demonstration examples may be used as references for generating training data.

As described above, domain data 310 is data associated with a specific domain and used to generate domain-specific training data. In certain embodiments, domain data 310 included in a prompt is the actual domain data that is to be used for generating training data. For example, if the domain data is an article associated with a particular domain (e.g., a real estate article), then the text of the article may be reproduced within the prompt. In certain embodiments, domain data 310 included in a prompt is an identifier of a location where the domain data can be found (e.g., such as in a storage, in memory, etc.). In certain embodiments, domain data 310 included in a prompt is a pointer to a location where the domain data can be found for generating the training data.

Formatting instructions 312 refer to a set of instructions explaining how to create training data for request 304. Formatting instructions 312 may dictate how the generated training data looks, the layout, the organization, the font, the size, the file format, etc. of the generated training data. In certain embodiments, formatting instructions 312 may instruct an LLM receiving a prompt with formatting instructions 312 to generate training data having a format similar to example training data 308 also included within the prompt. An example formatting instruction 312 included in a prompt may indicate that “The output should be a JavaScript Object Notation (JSON) file with one field called “turns”. . . ”

In certain embodiments, formatting instructions 312 included in a prompt may come from instructions in a configuration file, such as “instruction” parameter 212 included in configuration file 202 of FIG. 2. Put differently, formatting instructions 312 may be provided via an “instructions” parameter included in a configuration file triggering the generation of a prompt (e.g., according to prompt template 302).

A prompt including the request 304, guideline(s) 306, example training data 308, domain data 310, and/or formatting instructions 312 may be provided to an LLM to initiate the generation of domain-specific training data. The type of training data generated may be based on the request 304 included in the prompt (e.g., which is based on a generation task type included in a configuration file).

### Example Generation Tasks for Domain-Specific Training Data Generation

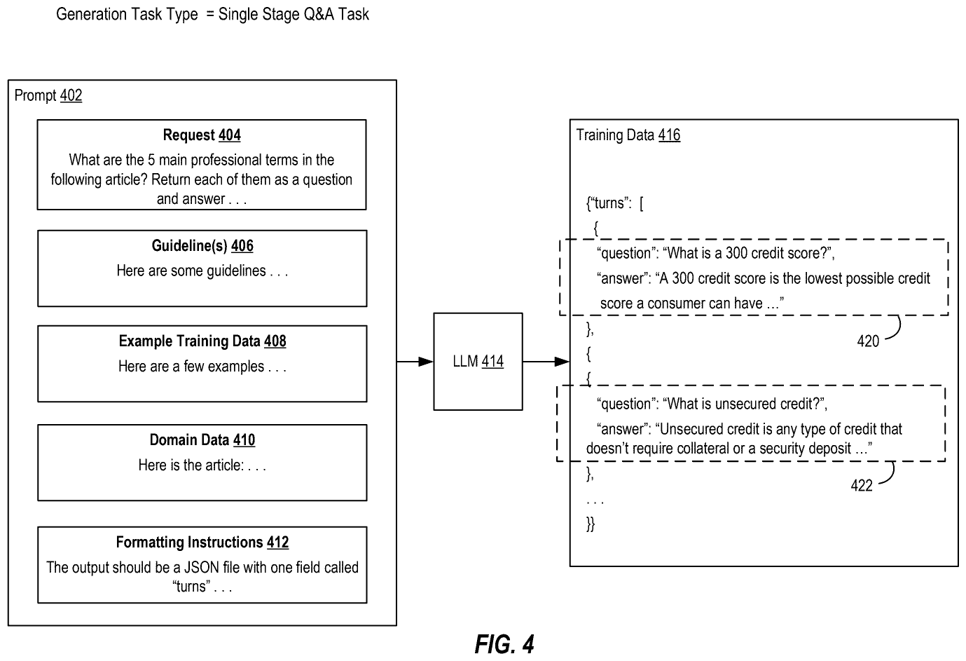

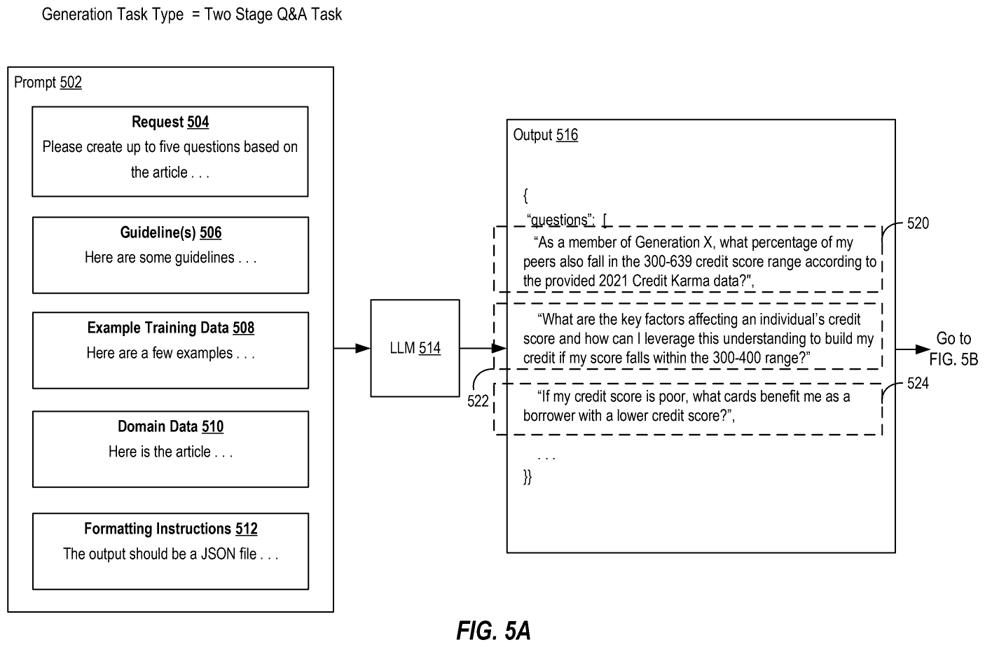

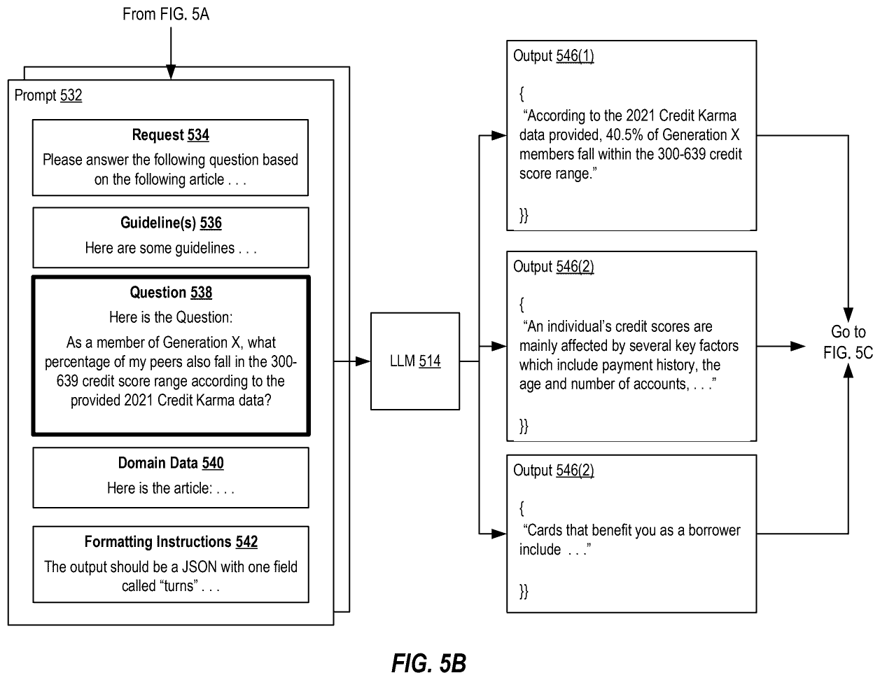

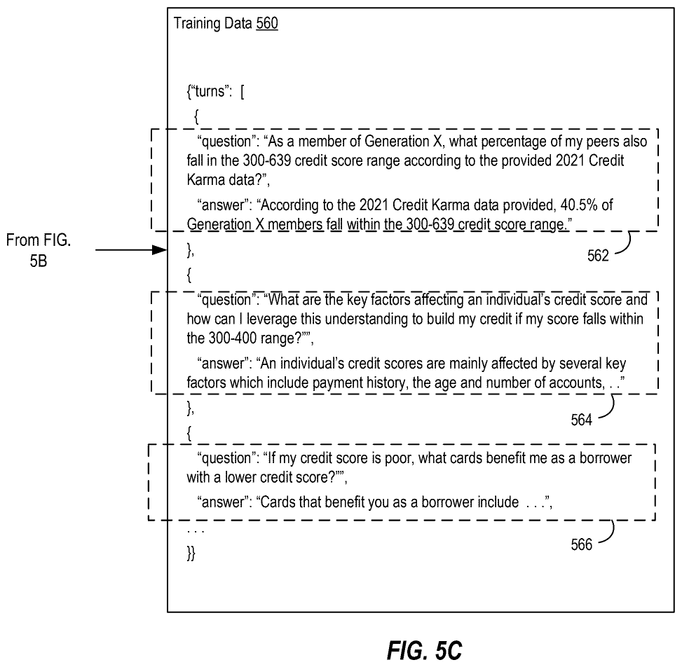

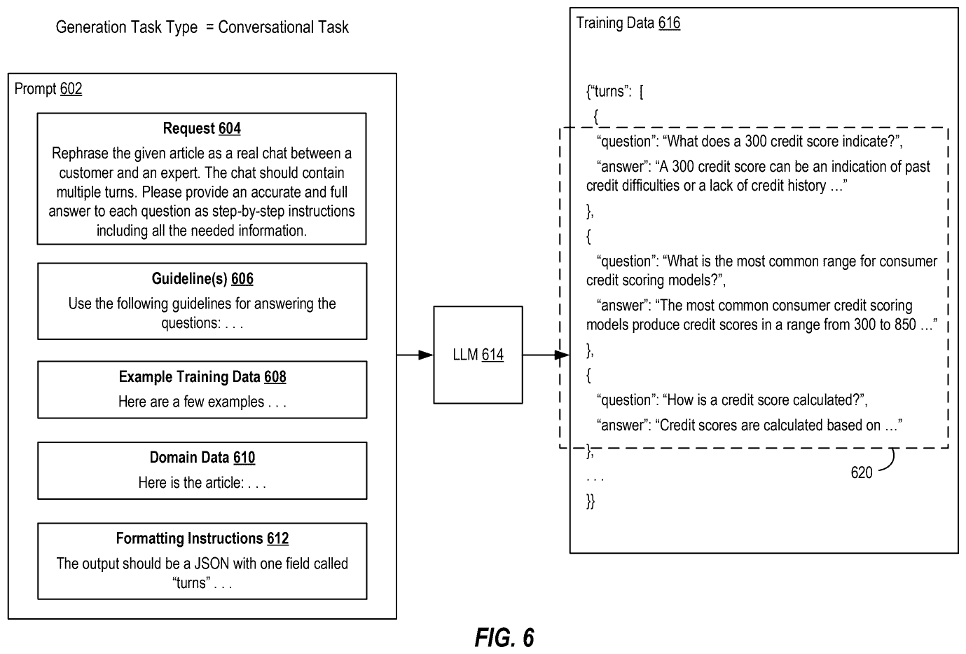

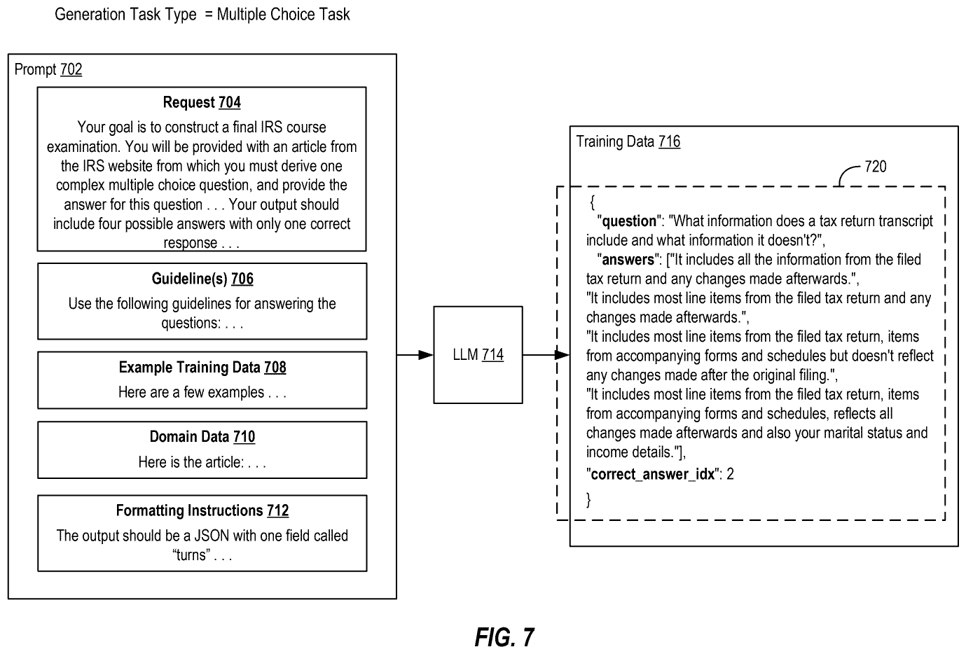

FIGS. 4-7 depict example generation of domain-specific training data for different generation tasks. For example, FIG. 4 depicts the example generation of domain-specific training data including question and answer pairs based on the execution of a single stage Q&A task. FIGS. 5A-5C depict the example generation of domain-specific training data including question and answer pairs based on the execution of a two stage Q&A task. FIG. 6 depicts the example generation of domain-specific training data including textual conversation(s) based on the execution of a conversational task. FIG. 7 depicts the example generation of domain-specific training data including multiple choice question and answer(s) based on the execution of multiple choice task. Different prompts and training data generated for each generation task are described with respect to FIGS. 4-7.

As shown in FIG. 4, for a single stage Q&A task, a prompt 402 (e.g., an example of prompt 110 in FIG. 1) may be generated to include a request 404 indicating to generate question and answer pairs. For example, request 404 recites:
“What are the 5 main professional terms in the following article? Return each of them as a question and answer . . . ”

Prompt 402 may also include guideline(s) 406 for generating the five question and answer pairs, example training data 408 including example question and answer pairs that may be generated in response to prompt 402, domain data 410 including the article referenced in request 404, and formatting instructions 412 indicating that the question and answer pairs should be output as a JSON file with one field called “turns.”

An LLM 414 (e.g., an example of LLM 114 in FIG. 1) may be prompted with prompt 402 to generate training data 416. Training data 416 may be a JSON file with one field called “turns”. Training data 416 may include at least a first question and answer pair 420 and a second question and answer pair 422 (as well as other question and answer pairs not shown in FIG. 4). First question and answer pair 420 and second question and answer pair 422 may be associated with a same domain as the article included as domain data 410 in prompt 402.

In another example, shown in FIGS. 5A-5C for a two stage Q&A task, a prompt 502 (e.g., a first prompt) (e.g., an example of prompt 110 in FIG. 1) may be generated to include a request 504 indicating to generate multiple questions. For example, request 504 recites:
“Please create up to five questions based on the article . . . ”

Prompt 502 may also include guideline(s) 506 for generating the five questions, example training data 508 including example questions that may be generated in response to prompt 502, domain data 510 including the article referenced in request 504, and formatting instructions 512 indicating that the questions should be output as a JSON file.

An LLM 514 (e.g., an example of LLM 114 in FIG. 1) may be prompted with prompt 502 to generate output 516. Output 516 may be a JSON file. Output 516 may include at least a first question 520, a second question 522, and a third question 524 (as well as two other questions not shown in FIG. 5A for a total of five questions generated by LLM 514). First question 520, second question 522, and third question 524 may each be associated with a same domain as the article included as domain data 510 in prompt 502. The generation of output 516 may be a first stage of the two stage Q&A task.

After generating output 516, additional prompts 532 (e.g., second prompts) (e.g., examples of prompt 110 in FIG. 1) may be generated (as shown in FIG. 5B). For example, one prompt 532 may be generated for each question included in output 516. Each prompt 532 may be generated to include a request 534 indicating to generate an answer for a specific question (e.g., a question previously generated by LLM 514). For example, in one prompt 532 associated with first question 520 in FIG. 5A, the request 534 recites:
“Please answer the following question based on the following article . . . ”
   and prompt 532 further includes question 538, which is first question 520 in FIG. 5A, reciting:
“As a member of Generation X, what percentage of my peers also fall in the 300-639 credit score range according to the provided 2021 Credit Karma data?”

Prompt 532 may also include guideline(s) 536 for generating the answer for question 538, domain data 540 including the article referenced in request 534, and formatting instructions 542 indicating that the answer should be output as a JSON file.

LLM 514 may be prompted with each prompt 532 (e.g., generated for each question generated in output 516 in FIG. 5A) to generate multiple outputs 546. For example, output 546(1) may be generated by LLM 514 when prompted with a first prompt 532(1) associated with first question 520 in FIG. 5A. Output 546(2) may be generated by LLM 514 when prompted with a second prompt 532(2) associated with second question 522 in FIG. 5A. Output 546(3) may be generated by LLM 514 when prompted with a third prompt 532(3) associated with third question 524 in FIG. 5A. Although FIG. 5B depicts only three outputs 546, at least two other outputs may be generated such that a total of five outputs 546 (e.g., a total of five answers to five questions) are generated.

After generating outputs 546, training data 560 is created. Training data 560 may include multiple question and answer pairs generated based on output 516 in FIG. 5A and outputs 546 in FIG. 5B. For example, a first question and answer pair 562 may be generated based on first question 520 in FIG. 5A and output 546(1) in FIG. 5B. A second question and answer pair 564 may be generated based on second question 522 in FIG. 5A and output 546(2) in FIG. 5B. Further, a third question and answer pair 566 may be generated based on third question 524 in FIG. 5A and output 546(3) in FIG. 5B. Although FIG. 5C depicts only three question and answer pairs, at least two other question and answer pairs may be included in training data 560 such that a total of five question and answer pairs exist in training data 560.

In another example, shown in FIG. 6 for a conversational task, a prompt 602 (e.g., an example of prompt 110 in FIG. 1) may be generated to include a request 604 indicating to generate a real chat between a customer and an expert, including multiple questions and answers that may be exchanged between the customer and the expert. For example, request 604 recites:
“Rephrase the given article as a real chat between a customer and an expert. The chat should contain multiple turns. Please provide an accurate and full answer to each question as step-by-step instructions including all the needed information.”

Prompt 602 may also include guideline(s) 606 for generating the real chat, example training data 608 including example chat that may be generated in response to prompt 602, domain data 610 including the article referenced in request 604, and formatting instructions 612 indicating that the real chat should be output as a JSON file with one field called “turns.”

An LLM 614 (e.g., an example of LLM 114 in FIG. 1) may be prompted with prompt 602 to generate training data 616. Training data 616 may be a JSON file with one field called “turns.” Training data 616 may comprise a chat 620 including at multiple question and answer pairs. Although only three question and answer pairs are included in chat 620 in FIG. 6, in some other example, chat 620 may include more or less and/or different question and answer pairs. Chat 620 may be associated with a same domain as the article included as domain data 610 in prompt 602.

In another example, shown in FIG. 7 for a multiple choice task, a prompt 702 (e.g., an example of prompt 110 in FIG. 1) may be generated to include a request 704 indicating to generate a multiple choice question and corresponding answers, where only one of the answers is correct. For example, request 704 recites:
“Your goal is to construct a final IRS course examination. You will be provided with an article from the IRS website from which you must derive one complex multiple choice question, and provide the answer for this question . . . Your output should include four possible answers with only one correct response . . . ”Prompt 702 may also include guideline(s) 706 for generating the multiple choice

question and answers, example training data 708 including example multiple choice questions and corresponding answers that may be generated in response to prompt 702, domain data 710 including the article referenced in request 704, and formatting instructions 712 indicating that the multiple choice question and answers should be output as a JSON file with one field called “turns.”

An LLM 714 (e.g., an example of LLM 114 in FIG. 1) may be prompted with prompt 702 to generate training data 716. Training data 716 may be a JSON file with one field called “turns.” Training data 716 may comprise a multiple choice question and answers, along with an indication of the correct answer, as shown at 720 in FIG. 7. For example, the multiple choice question recites:
“What information does a tax return transcript include and what information it doesn't?,”
   the possible answers include:
First Answer—“It includes all the information from the filed tax return and any changes made afterwards,”
Second Answer—“It includes most line items from the filed tax return and any changes made afterwards,”
Third Answer—“It includes most line items from the filed tax return, items from accompanying forms and schedules but doesn't reflect any changes made after the original filing,” and
Fourth Answer—“It includes most line items from the filed tax return, items from accompanying forms and schedules, reflects all changes made afterwards and also your marital status and income details,”
   and the correct answer is identified as the second answer based on:
“correct_answer_idx”: 2.”

Although only one multiple choice question, and its corresponding answers, are generated in training data 716 in FIG. 7, in some other example, training data 716 may include more or less and/or different multiple choice questions and answers. The multiple choice question and answers, shown at 720 in FIG. 7, may be associated with a same domain as the article included as domain data 710 in prompt 702.

In certain embodiments, training data 716 is used to benchmark another LLM to evaluate a performance of the LLM. For example, the LLM may be asked the question “What information does a tax return transcript include and what information it doesn't?,” to determine if the LLM responds with the correct answer.

Example Method for Generating Domain-Specific Training Data for LLM Fine-Tuning and/or Benchmarking

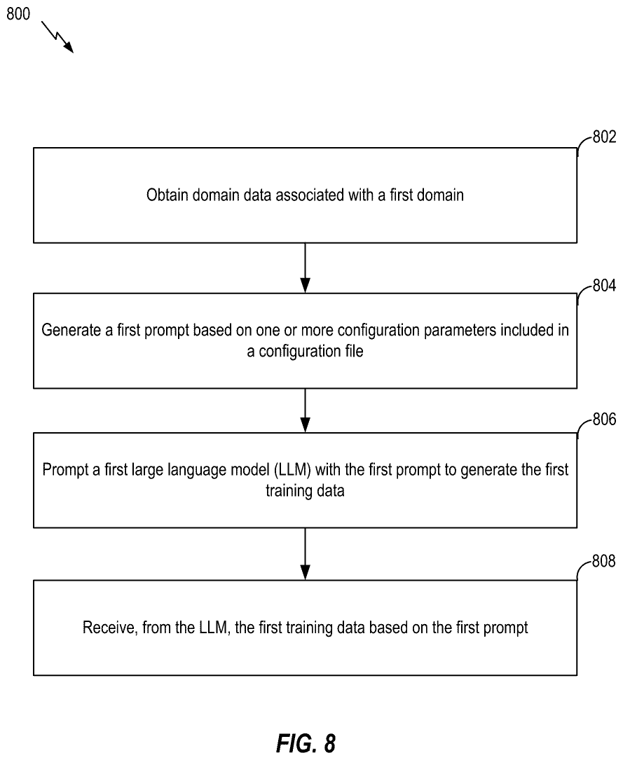

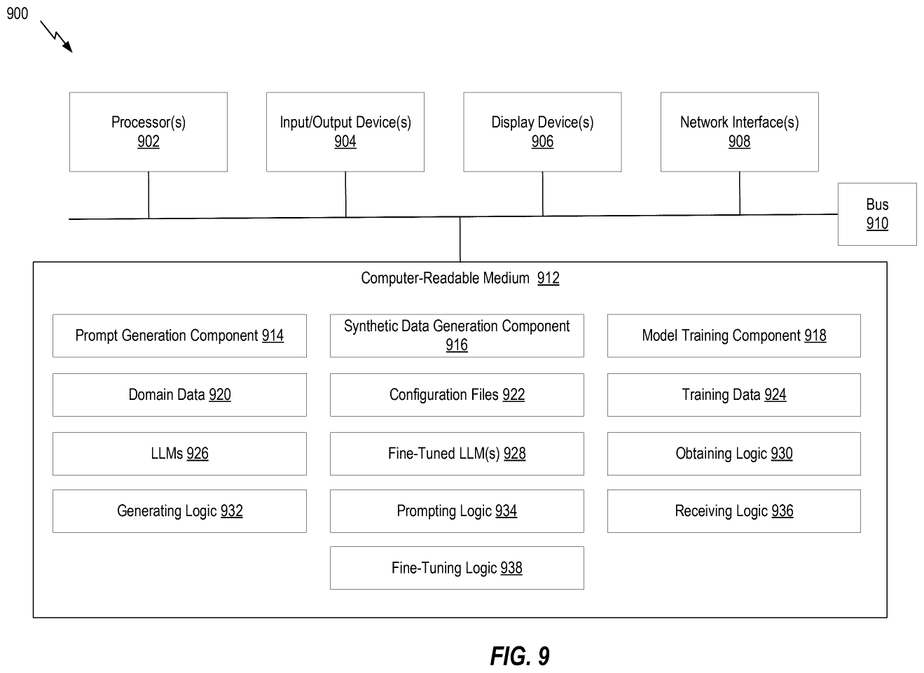

FIG. 8 depicts an example method 800 for generating domain-specific training data for LLM fine-tuning and/or benchmarking. Method 800 may be performed by one or more processor(s) of a computing device, such as processor(s) 902 of processing system 900 described below with respect to FIG. 9.

Method 800 begins, at block 802, with obtaining domain data associated with a first domain.

Method 800 proceeds, at block 804, with generating a first prompt based on one or more configuration parameters included in a configuration file. The first prompt may include: (1) a request to generate first training data for the first domain based on the domain data; (2) one or more first guidelines for generating the first training data; (3) example first training data for the first domain; and (4) the domain data. In certain embodiments, the first training data includes: a first plurality of question and answer pairs; a conversation comprising a first plurality of questions and a first plurality of answers corresponding to the first plurality of questions; a second plurality of questions; or a question and a second plurality of answers corresponding to the question.

Method 800 proceeds, at block 806, with prompting a first LLM with the first prompt to generate the first training data.

Method 800 proceeds, at block 808, with receiving, from the LLM, the first training data based on the first prompt.

In certain embodiments, method 800 further includes fine-tuning a second LLM for the first domain using the first training data.

In certain embodiments, the first training data includes the second plurality of questions. In certain embodiments, method 800 further includes, for each respective question of the second plurality of questions: automatically generating a second prompt based on the one or more configuration parameters included in the configuration file; prompting the first LLM with the second prompt to generate the second training data; receiving, from the LLM, the second training data based on the first prompt; and generating third training data based on the first training data and the second training data comprising a second plurality of question and answer pairs; and fine-tuning a second LLM for the first domain using the third training data. The second prompt may include: a second request to generate second training data for the first domain based on the respective question and the domain data, wherein the second training data comprises an answer corresponding to the respective question; one or more second guidelines for generating the second training data; the respective question; and the domain data.

In certain embodiments, the first training data includes the question and the second plurality of answers corresponding to the question, and only one answer of the second plurality of answers comprises a correct answer to the question.

In certain embodiments, the one or more first guidelines includes at least one of: a first suggestion to consider different granularities associated with the first domain when generating the first training data; or a second suggestion to consider different nuances associated with the first domain when generating the first training data.

In certain embodiments, the first prompt further includes formatting instructions for formatting the first training data.

In certain embodiments, the one or more configuration parameters include: an indication of a type of the first training data; an indication of a type of the domain data; an indication of the first LLM; and the one or more first guidelines for generating the first training data.

Method 800 for generating domain-specific training data may provide various beneficial technical effects and/or advantages. For example, method 800 enables the efficient generation of high quality training data for various domains to enable improved LLM fine-tuning for different domains. The efficient process is attributable to the use of configuration files to carry out the training data generation, as well as the ability of the data builder system to perform generation tasks simultaneously. The improved quality of the training data may be attributable to the additional information included in prompt(s) used to generate the training data. For example, by including various guidelines and/or examples in the prompt, the training data that is generated by an LLM provided the prompt, may be more accurate and/or responsive to the prompt. The improved quality of the training data may also be attributable to the ability to generate various types of training data having various formats using the different configuration files, such that the training data generated for a particular domain is diverse and is less likely to result in AI bias when used to fine-tune an LLM.

Note that FIG. 8 is just one example of a method, and other methods including fewer, additional, or alternative steps are possible consistent with this disclosure.

### Example Processing System for Synthetic Data Generation at Sale

FIG. 9 depicts an example processing system 900 configured to perform various aspects described herein, including, for example, method 800 as described above with respect to FIG. 8.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes prompt generation component 914, synthetic data generation component 916, model training component 918, domain data 920, configuration files 922, training data 924, LLMs 926, fine-tuned LLM(s) 928, obtaining logic 930, generating logic 932, prompting logic 934, receiving logic 936, and fine-tuning logic 938.

In certain embodiments, obtaining logic 930 includes logic for obtaining domain data associated with a first domain.

In certain embodiments, generating logic 932 includes logic for generating a first prompt based on one or more configuration parameters included in a configuration file. In certain embodiments, generating logic 932 includes logic for, for each respective question of the second plurality of questions: automatically generating a second prompt based on the one or more configuration parameters included in the configuration file. In certain embodiments, generating logic 932 includes logic for generating third training data based on the first training data and the second training data comprising a second plurality of question and answer pairs.

In certain embodiments, prompting logic 934 includes logic for prompting a first large language model (LLM) with the first prompt to generate the first training data.

In certain embodiments, receiving logic 936 includes logic for receiving, from the LLM, the first training data based on the first prompt.

In certain embodiments, fine-tuning logic 938 includes logic for fine-tuning a second LLM for the first domain using the first training data. In certain embodiments, fine-tuning logic 938 includes logic for fine-tuning a second LLM for the first domain using the third training data.

Note that FIG. 9 is just one example of a processing system consistent with aspects described herein, and other processing systems having additional, alternative, or fewer components are possible consistent with this disclosure.

### Example Clauses

Implementation examples are described in the following numbered clauses:
Clause 1: A method, comprising: obtaining domain data associated with a first domain; generating a first prompt based on one or more configuration parameters included in a configuration file, the first prompt comprising: a request to generate first training data for the first domain based on the domain data, wherein the first training data comprises: a first plurality of question and answer pairs; a conversation comprising a first plurality of questions and a first plurality of answers corresponding to the first plurality of questions; a second plurality of questions; or a question and a second plurality of answers corresponding to the question; one or more first guidelines for generating the first training data; example first training data for the first domain; and the domain data; prompting a first large language model (LLM) with the first prompt to generate the first training data; and receiving, from the LLM, the first training data based on the first prompt.
Clause 2: The method of Clause 1, further comprising fine-tuning a second LLM for the first domain using the first training data.
Clause 3: The method of any one of Clauses 1-2, wherein: the first training data comprises the second plurality of questions; and the method further comprises: for each respective question of the second plurality of questions: automatically generating a second prompt based on the one or more configuration parameters included in the configuration file, the second prompt comprising: a second request to generate second training data for the first domain based on the respective question and the domain data, wherein the second training data comprises an answer corresponding to the respective question; one or more second guidelines for generating the second training data; the respective question; and the domain data; prompting the first LLM with the second prompt to generate the second training data; receiving, from the LLM, the second training data based on the first prompt; and generating third training data based on the first training data and the second training data comprising a second plurality of question and answer pairs; and fine-tuning a second LLM for the first domain using the third training data.
Clause 4: The method of any one of Clauses 1-3, wherein: the first training data comprises the question and the second plurality of answers corresponding to the question, and only one answer of the second plurality of answers comprises a correct answer to the question.
Clause 5: The method of any one of Clauses 1-4, wherein the one or more first guidelines comprise at least one of: a first suggestion to consider different granularities associated with the first domain when generating the first training data; or a second suggestion to consider different nuances associated with the first domain when generating the first training data.
Clause 6: The method of any one of Clauses 1-5, wherein the first prompt further comprises formatting instructions for formatting the first training data.
Clause 7: The method of any one of Clauses 1-6, wherein the one or more configuration parameters comprise: an indication of a type of the first training data; an indication of a type of the domain data; an indication of the first LLM; and the one or more first guidelines for generating the first training data.
Clause 8: A processing system, comprising: a memory comprising computer-executable instructions; and a processor configured to execute the computer-executable instructions and cause the processing system to perform a method in accordance with any one of Clauses 1-7.
Clause 9: A processing system, comprising means for performing a method in accordance with any one of Clauses 1-7.
Clause 10: A non-transitory computer-readable medium storing program code for causing a processing system to perform the steps of any one of Clauses 1-7.
Clause 11: A computer program product embodied on a computer-readable storage medium comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
obtaining domain data associated with a first domain;
generating a first prompt based on one or more configuration parameters included in a configuration file, the first prompt comprising:
a request to generate first training data for the first domain based on the domain data, wherein the first training data comprises:
a first plurality of question and answer pairs;
a conversation comprising a first plurality of questions and a first plurality of answers corresponding to the first plurality of questions;
a second plurality of questions; or
a question and a second plurality of answers corresponding to the question; one or more first guidelines for generating the first training data;
example first training data for the first domain; and
the domain data;
prompting a first large language model (LLM) with the first prompt to generate the first training data; and
receiving, from the LLM, the first training data based on the first prompt.

2. The method of claim 1, further comprising fine-tuning a second LLM for the first domain using the first training data.

3. The method of claim 1, wherein:
the first training data comprises the second plurality of questions; and
the method further comprises:
for each respective question of the second plurality of questions:
automatically generating a second prompt based on the one or more configuration parameters included in the configuration file, the second prompt comprising:
a second request to generate second training data for the first domain based on the respective question and the domain data, wherein the second training data comprises an answer corresponding to the respective question;
one or more second guidelines for generating the second training data;
the respective question; and
the domain data;
prompting the first LLM with the second prompt to generate the second training data;
receiving, from the LLM, the second training data based on the first prompt; and
generating third training data based on the first training data and the second training data comprising a second plurality of question and answer pairs; and
fine-tuning a second LLM for the first domain using the third training data.

4. The method of claim 1, wherein:
the first training data comprises the question and the second plurality of answers corresponding to the question, and
only one answer of the second plurality of answers comprises a correct answer to the question.

5. The method of claim 1, wherein the one or more first guidelines comprise at least one of:
a first suggestion to consider different granularities associated with the first domain when generating the first training data; or
a second suggestion to consider different nuances associated with the first domain when generating the first training data.

6. The method of claim 1, wherein the first prompt further comprises formatting instructions for formatting the first training data.

7. The method of claim 1, wherein the one or more configuration parameters comprise:
an indication of a type of the first training data;
an indication of a type of the domain data;
an indication of the first LLM; and
the one or more first guidelines for generating the first training data.

8. A processing system, comprising:
one or more memories comprising computer-executable instructions; and
one or more processors configured to execute the computer-executable instructions and cause the processing system to:
obtain domain data associated with a first domain;
generate a first prompt based on one or more configuration parameters included in a configuration file, the first prompt comprising:
a request to generate first training data for the first domain based on the domain data, wherein the first training data comprises:
a first plurality of question and answer pairs;
a conversation comprising a first plurality of questions and a first plurality of answers corresponding to the first plurality of questions;
a second plurality of questions; or
a question and a second plurality of answers corresponding to the question;
one or more first guidelines for generating the first training data;
example first training data for the first domain; and
the domain data;
prompt a first large language model (LLM) with the first prompt to generate the first training data; and
receive, from the LLM, the first training data based on the first prompt.

9. The processing system of claim 8, wherein the one or more processors are configured to execute the computer-executable instructions and cause the processing system to fine-tune a second LLM for the first domain using the first training data.

10. The processing system of claim 8, wherein:
the first training data comprises the second plurality of questions; and
the one or more processors are configured to execute the computer-executable instructions and cause the processing system to:
for each respective question of the second plurality of questions:
automatically generate a second prompt based on the one or more configuration parameters included in the configuration file, the second prompt comprising:
a second request to generate second training data for the first domain based on the respective question and the domain data, wherein the second training data comprises an answer corresponding to the respective question;
one or more second guidelines for generating the second training data;
the respective question; and
the domain data;
prompt the first LLM with the second prompt to generate the second training data;
receive, from the LLM, the second training data based on the first prompt; and
generate third training data based on the first training data and the second training data comprising a second plurality of question and answer pairs; and
fine-tune a second LLM for the first domain using the third training data.

11. The processing system of claim 8, wherein:
the first training data comprises the question and the second plurality of answers corresponding to the question, and
only one answer of the second plurality of answers comprises a correct answer to the question.

12. The processing system of claim 8, wherein the one or more first guidelines comprise at least one of:
a first suggestion to consider different granularities associated with the first domain when generating the first training data; or
a second suggestion to consider different nuances associated with the first domain when generating the first training data.

13. The processing system of claim 8, wherein the first prompt further comprises formatting instructions for formatting the first training data.

14. The processing system of claim 8, wherein the one or more configuration parameters comprise:
an indication of a type of the first training data;
an indication of a type of the domain data;
an indication of the first LLM; and
the one or more first guidelines for generating the first training data.
